(19) United States
(12) Patent Application Publication
(10) Pub. No.: US 2014/0279243 A1
(43) Pub. Date: Sep. 18, 2014

(54) CROWD SOURCING AND MACHINE LEARNING BASED SIZE MAPPER

(71) Applicants: Gaurav Kukal, San Jose, CA (US); Dane Glasgow, Los Altos, CA (US)

(72) Inventors: Gaurav Kukal, San Jose, CA (US); Dane Glasgow, Los Altos, CA (US)

(73) Assignee: eBay Inc., San Jose, CA (US)

(21) Appl. No.: 13/840,777

(22) Filed: Mar. 15, 2013

(51) Int. Cl. G06Q 30/06; G06N 99/00

(52) U.S. Cl. CPC G06Q 30/0623; G06N 99/005
USPC 705/26.61

(57) ABSTRACT

Embodiments for obtaining size and brand information for a plurality of descriptors that include item types and that are associated with user profiles. The descriptors, size, and brand information are obtained by crowdsourcing and by data mining transaction data. Low confidence machine learned data may be boosted by crowdsourcing through targeted questions. Co-occurrences among descriptors are determined and categorized. Signal strength and confidence scores are calculated for the co-occurrences. Relationships between sizes and brands for the item types are calculated and confidence factors for the relationships are calculated.

### TECHNICAL FIELD

Example embodiments of the present disclosure relate generally to the field of computer technology and, more specifically, to providing and using a learning system for providing users a way to obtain the correct size of clothing across brands of that clothing.

### BACKGROUND

Websites provide a number of publishing, listing, and price-setting mechanisms whereby a publisher (e.g., a seller) may list or publish information concerning items for sale on its site, and where a visitor may view items on the site. Some of the items are clothing. But size analysis of a particular article of clothing in two different brands shows that, for example, size L in one brand may be not same as size L in another brand.

### BRIEF DESCRIPTION OF DRAWINGS

Embodiments described herein are illustrated by way of example and not limitation in the figures of the accompanying drawings, in which like reference numbers indicate similar elements and in which:

FIG. 1 is a block diagram illustrating a network system, according to an embodiment.

FIG. 2 is a block diagram of applications of the application servers that may form a part of the network system of FIG. 1, according to an embodiment.

FIG. 3 is a block diagram illustrating a size mapping application, according to an embodiment.

FIG. 4 is an illustration of size non-equality of a clothing item across various brands of the item.

FIG. 5 is an illustration of size normalization of a clothing item across various brands of the item.

FIG. 6 is an illustration of the work flow of an embodiment.

FIG. 7 is an illustration of a table of records captured by machine learning from transaction tables available to an ecommerce system.

FIG. 8 is an illustration of a table of records from crowdsourced data, and from machine learning data mined from transaction data available to the ecommerce system.

FIG. 9 is an illustration of a record matrix for which a signal strength score and a confidence score may be determined for profile entries, in accordance with an embodiment.

FIG. 10 is an illustration of records which have strong signal strength but low confidence, according to an embodiment.

FIG. 11 is an illustration of a relationship graph of an item for a descriptor across a plurality of brands of the item according to an embodiment;

FIG. 12 is an illustration of another type of relationship graph for an item for a descriptor across a plurality of brands of the item according to an embodiment.

FIG. 13 is an illustration of a co-occurrence of two records according to an embodiment.

FIG. 13A is an illustration of the number of co-occurrences in three records according to an embodiment and FIG. 13B is an illustration of a selection of a co-occurrence record according to an embodiment.

FIG. 13A is an illustration of the number of co-occurrences in three records according to an embodiment.

FIG. 14 is an illustration of a co-occurrence of two records for use in calculation of confidence of a size mapping.

FIG. 15 is an illustration of an operation of the workflow of FIG. 6 according to an embodiment.

FIG. 16 is a simplified block diagram of a machine in an example form of a computing system within which a set of instructions for causing the machine to perform any one or more of the methodologies discussed herein may be executed.

### DETAILED DESCRIPTION

The description that follows includes systems, methods, techniques, instruction sequences, and computing machine program products that embody illustrative embodiments of the present disclosure. In the following description, for purposes of explanation, numerous specific details are set forth in order to provide an understanding of various embodiments of the inventive subject matter. It will be evident, however, to those skilled in the art that embodiments of the disclosed subject matter may be practiced without these specific details. In general, well-known instruction instances, protocols, structures, and techniques have not been shown in detail.

As used herein, the term “or” may be construed in either an inclusive or exclusive sense. Additionally, although various example embodiments discussed below focus on a network-based publication system environment, the embodiments are given merely for clarity in disclosure. As used herein, “publication system” includes an ecommerce system. Thus, any type of electronic publication, electronic commerce, or electronic business system and method, including various system architectures, may employ various embodiments of the listing creation system and method described herein and may be considered as being within a scope of the example embodiments. Each of a variety of example embodiments may be discussed in detail below.

Online shopping for clothes poses an issue for users to obtain the desired size. This issue may be amplified by the fact that there may be no standardization of size across all brands. For example, there may be three leading brands of hooded jackets. But size L in Brand A 404 may not be the same as size L in Brand B or as size L in Brand C. The actual normalization gathered from real world experience may be, as seen in that size L of Brand A may be equal to size XL of Brand B which may be equal to size M of Brand C for hooded jackets. This issue may be alleviated by the embodiments described herein.

FIG. 1 may be a network diagram depicting a network system 100, according to one embodiment, having a client-server architecture configured for exchanging data over a network. For example, the network system 100 may include a network-based publisher 102 where clients may communicate and exchange data within the network system 100. The data may pertain to various functions (e.g., online item purchases) and aspects (e.g., managing content) associated with the network system 100 and its users. Although illustrated herein as a client-server architecture as an example, other embodiments may include other network architectures, such as a peer-to-peer or distributed network environment.

A data exchange platform, in an example form of a network-based publisher 102, may provide server-side functionality, via a network 104 (e.g., the Internet, wireless network, cellular network, or a Wide Area Network (WAN)) to one or more clients. The one or more clients may include users that utilize the network system 100 and more specifically, the network-based publisher 102, to exchange data over the network 104. These transactions may include transmitting, receiving (communicating) and processing data to, from, and regarding content and users of the network system 100. The data may include, but are not limited to, content and user data such as feedback data; user profiles; user attributes; product attributes; product and service reviews; product, service, manufacture, and vendor recommendations and identifiers; social network commentary, product and service listings associated with buyers and sellers; auction bids; and transaction data, among other things.

In various embodiments, the data exchanges within the network system 100 may be dependent upon user-selected functions available through one or more client or user interfaces (UIs). The UIs may be associated with a client device, such as a client device 110 using a web client 106. The web client 106 may be in communication with the network-based publisher 102 via a web server 116. The UIs may also be associated with a client device 112 using a programmatic client 108, such as a client application. It can be appreciated in various embodiments the client devices 110, 112 may be associated with a buyer, a seller, a third party electronic commerce platform, a payment service provider, or a shipping service provider, each in communication with the network-based publisher 102 and optionally each other. The buyers and sellers may be any one of individuals, merchants, or service providers, among other things. The client devices 110 and 112 may comprise a mobile phone, desktop computer, laptop, or any other communication device that a user may use to access the network-based publisher 102.

Turning specifically to the network-based publisher 102, an application program interface (API) server 114 and a web server 116 are coupled to, and provide programmatic and web interfaces respectively to, one or more application servers 118. The application servers 118 host one or more publication application(s) of publication system 120 and one or more payment systems 122. The application server(s) 118 are, in turn, shown to be coupled to one or more database server(s) 124 that facilitate access to one or more database(s) 126.

In one embodiment, the web server 116 and the API server 114 communicate and receive data pertaining to products, listings, transactions, social network commentary and feedback, among other things, via various user input tools. For example, the web server 116 may send and receive data to and from a toolbar or webpage on a browser application (e.g., web client 106) operating on a client device (e.g., client device 110). The API server 114 may send and receive data to and from an application (e.g., client application 108) running on another client device (e.g., client device 112).

The publication system 120 publishes content on a network (e.g., the Internet). As such, the publication system 120 provides a number of publication and marketplace functions and services to users that access the network-based publisher 102. For example, the publication application(s) of publication system 120 may provide a number of services and functions to users for listing goods and/or services for sale, facilitating transactions, and reviewing and providing feedback about transactions and associated users. Additionally, the publication application(s) of publication system 120 may track and store data and metadata relating to products, listings, transactions, and user interaction with the network-based publisher 102. The publication application(s) of publication system 120 may aggregate the tracked data and metadata to perform data mining to identify trends or patterns in the data. While the publication system 120 may be discussed in terms of a marketplace environment, it may be noted that the publication system 120 may be associated with a non-marketplace environment.

The payment system 122 provides a number of payment services and functions to users. The payment system 122 allows users to accumulate value (e.g., in a commercial currency, such as the U.S. dollar, or a proprietary currency, such as “points”) in accounts, and then later to redeem the accumulated value for products (e.g., goods or services) that are made available via the publication system 120. The payment system 122 also facilitates payments from a payment mechanism (e.g., a bank account, PayPal account, or credit card) for purchases of items via the network-based marketplace. While the publication system 120 and the payment system 122 are shown in FIG. 1 to both form part of the network-based publisher 102, it will be appreciated that, in alternative embodiments, the payment system 122 may form part of a payment service that may be separate and distinct from the network-based publisher 102.

### Application Server(s)

FIG. 2 illustrates a block diagram showing applications of application server(s) that are part of the network system 100, in an example embodiment. In this embodiment, the publication system 120, and the payment system 120 may be hosted by the application server(s) 118 of the network system 100. The publication system 120 and the payment system 132 may be hosted on dedicated or shared server machines (not shown) that are communicatively coupled to enable communications between server machines. The applications themselves may be communicatively coupled (e.g., via appropriate interfaces) to each other and to various data sources, so as to allow information to be passed between the applications or so as to allow the applications to share and access common data.

The publication system 120 are shown to include at least one or more auction application(s) 212 which support auction-format listing and price setting mechanisms (e.g., English, Dutch, Vickrey, Chinese, Double, Reverse auctions etc.). The auction application(s) 212 may also provide a number of features in support of such auction-format listings, such as a reserve price feature whereby a seller may specify a reserve price in connection with a listing and a proxy-bidding feature whereby a bidder may invoke automated proxy bidding. The auction-format offer in any format may be published in any virtual or physical marketplace medium and may be considered the point of sale for the commerce transaction between a seller and a buyer (or two users).

One or more fixed-price application(s) 214 support fixed-price listing formats (e.g., the traditional classified advertisement-type listing or a catalogue listing) and buyout-type listings. Specifically, buyout-type listings (e.g., including the Buy-It-Now® (BIN) technology developed by eBay Inc., of San Jose, Calif.) may be offered in conjunction with auction-format listings, and allow a buyer to purchase goods or services, which are also being offered for sale via an auction, for a fixed-price that may be typically higher than the starting price of the auction.

The application(s) of the application server(s) 118 may include one or more store application(s) 216 that allow a seller to group listings within a “virtual” store. The virtual store may be branded and otherwise personalized by and for the seller. Such a virtual store may also offer promotions, incentives and features that are specific and personalized to a relevant seller.

Navigation of the online marketplace may be facilitated by one or more navigation application(s) 220. For example, a search application (as an example of a navigation application) may enable key word searches of listings published via the network-based publisher 102. A browse application may allow users to browse various category, catalogue, or inventory data structures according to which listings may be classified within the network-based publisher 102. Various other navigation applications may be provided to supplement the search and browsing applications.

Merchandizing application(s) 222 support various merchandising functions that are made available to sellers to enable sellers to increase sales via the network-based publisher 102. The merchandizing application(s) 222 also operate the various merchandising features that may be invoked by sellers, and may monitor and track the success of merchandising strategies employed by sellers.

Personalization application(s) 230 allow users of the network-based publisher 102 to personalize various aspects of their interactions with the network-based publisher 102. For example, a user may, utilizing an appropriate personalization application 230, create a personalized reference page at which information regarding transactions to which the user may be (or has been) a party may be viewed. Further, the personalization application(s) 230 may enable a third party to personalize products and other aspects of their interactions with the network-based publisher 102 and other parties, or to provide other information, such as relevant business information about themselves.

The publication system 120 may include one or more internationalization application(s) 232. In one embodiment, the network-based publisher 102 may support a number of marketplaces that are customized, for example, for specific geographic regions. A version of the network-based publisher 102 may be customized for the United Kingdom, whereas another version of the network-based publisher 102 may be customized for the United States. Each of these versions may operate as an independent marketplace, or may be customized (or internationalized) presentations of a common underlying marketplace. The network-based publisher 102 may accordingly include a number of internationalization application(s) 232 that customize information (and/or the presentation of information) by the network-based publisher 102 according to predetermined criteria (e.g., geographic, demographic or marketplace criteria). For example, the internationalization application(s) 232 may be used to support the customization of information for a number of regional websites that are operated by the network-based publisher 102 and that are accessible via respective web servers.

Reputation application(s) 234 allow users that transact, utilizing the network-based publisher 102, to establish, build and maintain reputations, which may be made available and published to potential trading partners. Consider that where, for example, the network-based publisher 102 supports person-to-person trading, users may otherwise have no history or other reference information whereby the trustworthiness and credibility of potential trading partners may be assessed. The reputation application(s) 234 allow a user, for example through feedback provided by other transaction partners, to establish a reputation within the network-based publisher 102 over time. Other potential trading partners may then reference such a reputation for the purposes of assessing credibility and trustworthiness.

In order to make listings, available via the network-based publisher 102, as visually informing and attractive as possible, the publication system 120 may include one or more imaging application(s) 236 utilizing which users may upload images for inclusion within listings. An imaging application 236 also operates to incorporate images within viewed listings. The imaging application(s) 236 may also support one or more promotional features, such as image galleries that are presented to potential buyers. For example, sellers may generally pay an additional fee to have an image included within a gallery of images for promoted items.

The publication system 120 may include one or more offer creation application(s) 238. The offer creation application(s) 238 allow sellers conveniently to author products pertaining to goods or services that they wish to transact via the network-based publisher 102. Offer management application(s) 240 allow sellers to manage offers, such as goods, services, or donation opportunities. Specifically, where a particular seller has authored and/or published a large number of products, the management of such products may present a challenge. The offer management application(s) 240 provide a number of features (e.g., auto-reproduct, inventory level monitors, etc.) to assist the seller in managing such products. One or more post-offer management application(s) 242 also assist sellers with a number of activities that typically occur post-offer. For example, upon completion of an auction facilitated by one or more auction application(s) 212, a seller may wish to leave feedback regarding a particular buyer. To this end, a post-offer management application 242 may provide an interface to one or more reputation application(s) 234, so as to allow the seller conveniently to provide feedback regarding multiple buyers to the reputation application(s) 234.

The dispute resolution application(s) 246 may provide mechanisms whereby disputes arising between transacting parties may be resolved. For example, the dispute resolution application(s) 246 may provide guided procedures whereby the parties are guided through a number of steps in an attempt to settle a dispute. In the event that the dispute cannot be settled via the guided procedures, the dispute may be escalated to a mediator or arbitrator.

The fraud prevention application(s) 248 may implement various fraud detection and prevention mechanisms to reduce the occurrence of fraud within the network-based publisher 102. The fraud prevention application(s) may prevent fraud with respect to the third party and/or the client user in relation to any part of the request, payment, information flows and/or request fulfillment. Fraud may occur with respect to unauthorized use of financial instruments, non-delivery of goods, and abuse of personal information.

Authentication application(s) 250 may verify the identity of a user, and may be used in conjunction with the fraud prevention application(s) 248. The user may be requested to submit verification of identity, an identifier upon making the purchase request, for example. Verification may be made by a code entered by the user, a cookie retrieved from the device, a phone number/identification pair, a username/password pair, handwriting, and/or biometric methods, such as voice data, face data, iris data, finger print data, and hand data. In some embodiments, the user may not be permitted to login without appropriate authentication. The system (e.g., the FSP) may automatically recognize the user, based upon the particular network-based device used and a retrieved cookie, for example.

The network-based publisher 102 itself, or one or more parties that transact via the network-based publisher 102, may operate loyalty programs and other types of promotions that are supported by one or more loyalty/promotions application(s) 254. For example, a buyer/client user may earn loyalty or promotions points for each transaction established and/or concluded with a particular seller/third party, and may be offered a reward for which accumulated loyalty points can be redeemed.

The application server(s) 118 may include messaging application(s) 256. The messaging application(s) 256 are responsible for the generation and delivery of messages to client users and third parties of the network-based publisher 102. Information in these messages may be pertinent to services offered by, and activities performed via, the payment system 120. Such messages, for example, advise client users regarding the status of products (e.g., providing “out of stock” or “outbid” notices to client users) or payment status (e.g., providing invoice for payment, Notification of a Payment Received, delivery status, invoice notices). Third parties may be notified of a product order, payment confirmation and/or shipment information. Respective messaging application(s) 256 may utilize any one of a number of message delivery networks and platforms to deliver messages to users. For example, messaging application(s) 256 may deliver electronic mail (email), instant message (IM), Short Message Service (SMS), text, facsimile, or voice (e.g., Voice over IP (VoIP)) messages via the wired (e.g., the Internet), Plain Old Telephone Service (POTS), or wireless (e.g., mobile, cellular, WiFi, WiMAX) networks.

The payment system 120 may include one or more payment processing application(s) 258. The payment processing application(s) 258 may receive electronic invoices from the merchants and may receive payments associated with the electronic invoices. The payment system 120 may also make use of functions performed by some applications included in the publication system 120.

The publication system 120 may include one or more size mapping applications 260. The size mapping applications may receive crowdsourced data from users and machine learning, or data mining, data from analysis of transaction data logs available to an ecommerce or other system. This data may then be operated on to normalize sizes of a particular item across various brands of that item.

Referring now to FIG. 3, an example block diagram illustrating an embodiment of a size mapping application according to an embodiment. FIG. 3 may be a block diagram illustrating an embodiment of a size mapping application according to an embodiment. Crowdsourcing module 305 may receive information from users relating to sizes of items of various brands. This information may be solicited from a community in a participatory activity, whether online or offline. Machine learning module 310 may use data mining techniques to provide information of the same type as that provided by crowdsourcing module 301. This machine learning information may be provided by mining, in one embodiment, transaction data available to an ecommerce system. Confidence boosting module 315 may operate on data from crowdsourced module 305 and machine learning module 310 where the confidence of the data might not be high, in order to increase the confidence. In one embodiment this may be done by asking users targeted questions about the data. Relationship module 320 may algorithmically provide relationships among items sizes and brands, and the confidence score for such relationships, for the data provided by crowdsourcing module 305 and machine learning module 310. This calculation may use co-occurrence data, the gap in time from when the co-occurrence data was obtained, the signal strength score and confidence score for profiles in co-occurrences, and the frequency score associated with co-occurrences, as described in more detail below.

Online shopping for clothes poses issues for users to obtain the desired size. This issue may be amplified by the fact that there may be no standardization of size across all brands. FIG. 4 depicts this problem. In FIG. 4 three leading brands are shown with hooded jackets. But size L 402 in Brand A 404 may be not same (indicated by the symbol 406) as size L 408 in Brand B 410 or as size L 412 in Brand C 414. The actual normalization gathered from real world experience may be, as seen in FIG. 5, that size L 402 of Brand A 404 may be equal (indicated by the symbol 506) to size XL 508 of Brand B 410 which may be equal to size M 510 of Brand C 414 for hooded jackets.

A shopper may think that he wears size L 402 of Brand A 404 but does not know whether size L 408 of Brand B 410 will fit him. So he decides to stick to Brand A only. The shopper may reason that it may be not worth taking a risk since, in a particular situation, returns are not free. Online shoppers may be hesitant to go out of their comfort zone. So when shopping online, shoppers may often stick to what they usually buy in physical stores. If a shopper wears Levis Jeans size 34 in a physical store, he would stick to Levis Jeans in size 34 even in the online world. He may not even think of trying Calvin Klein jeans because he wants to make what he considers an informed decision in staying with the brand he knows.

Another shopper may notice that there may be a really good deal on Hanes jackets on eBay. So he decides to order size L, thinking that if it does not fit then he will return it.

Buyers who are willing to take risks online may experience extra expense if the clothes they bought do not fit them as expected. They may end up returning the clothes or end up being an unhappy online shopper. When clothes are returned, either the seller experiences extra expense if the return may be free, or buyers experience extra expense if they have to pay for returns. In both cases there may be a waste of money.

This dilemma may be resolved in large part by mining historical sales data using a combination of crowdsourcing and machine learning as illustrated by work flow 600 of FIG. 6, which will be discussed in detail blow. In each process, crowdsourcing and machine learning from transaction data, the type of data resulting from the processes will be the same type of data. In each process the time stamp of the data record, i.e., when the data was captured, may be obtained and stored with the record. The longer ago the size data was captured the less confidence there may be that it may be accurate because people's sizes change over time. A user's size today may not be the same as the user's size information captured a year ago.

Crowdsourcing may be viewed as obtaining services, ideas, or content by soliciting contributions from an online community in a participatory online activity, although the process may also be performed offline as well. In one case, information may be requested to an unknown group of information providers who then submit the information. An alternative process for obtaining such services, ideas, or content may also be accomplished by mining historical data from sales logs of transaction data from a transaction facility, for example. This may be sometimes called machine learning.

### Crowdsourcing

In one embodiment, crowdsourcing may be used by asking users to create user profiles 610 of FIG. 6 in clothing, shoes, accessories (CSA) categories. Other categories may be used. When used for the CSA category, crowdsourced data may include a profile ID 611, clothing items 612 they purchase, their sizes 613 for those clothing items, their brands 614, and other data in clothing, or in shoes, or in accessory categories, in one embodiment, by asking users to input information relating to the category involved in a format such as:
Clothing line 612 (e.g. sweatshirt, T-shirt, Jeans, and the like)
Size 613 (e.g. L, XL, XXL based on the clothing line)
Brand 614 (e.g. Gap, Banana Republic, Tommy Hilfiger, and other brands)
Age Group 615 (e.g. Adults or Kids)
Gender 616 (e.g. Male or Female)

The user may be encouraged to provide at least two inputs in each clothing line. This tends to provide high confidence signals for use in ultimately recommending equivalent item sizes across brands of the same item.

### Machine Learning

Machine learning may be viewed in one instance as the study of systems that can learn from data. For example, a machine learning system could be trained on email messages in some industries to learn to distinguish between spam and non-spam messages. After learning, the system can then be used to classify new email messages into spam and non-spam categories.

Machine learning deals with representation and generalization. Representation of data instances and functions evaluated on these instances are part of all machine learning systems. Generalization may be the property that the system will perform well on unseen data instances; the conditions under which this can be guaranteed are a key object of study in the subfield of computational learning theory.

Machine learning may be viewed as having a focus on prediction, based on known properties that are learned from training data. Data mining (which may be the analysis step of Knowledge Discovery in Databases) focuses on the discovery of previously unknown properties on the data. Machine learning and data mining may overlap. For example, data mining uses many machine learning methods, but often with an aim at a different goal. Machine learning also employs data mining methods such as unsupervised learning or as a preprocessing step to improve learner accuracy.

In the online marketing industry, data mining and machine learning may be used on transaction data from user accounts at an ecommerce system. From one user account, for example, multiple profiles can be generated. If there are multiple transactions over a period of time e.g., one involving boys t-shirt and other as men's sweatshirt then there may be two profiles created for that user, one for men's clothing and one for boy's clothing. This may be indicated at 620 of FIG. 6. Such sales data from a transaction system can result in a sparse matrix. This matrix may provide data in the following format, similar to the format for crowdsourcing, such as:
PROFILE ID
Size
Clothing line
Brand
AGE GROUP
GENDER
TIMESTAMP of transaction

This may be seen in more detail in FIG. 7 which illustrates machine learning (or transaction) data. FIG. 7 illustrates records captured by machine learning from transaction tables available to ecommerce system, and may be kept in lookup table 700. Table 700 illustrates data records from three users from whose ecommerce transactions data may be obtained (machine learning data, or “transaction data”). While the table of FIG. 7 indicates only three users, it will be appreciated by those of ordinary skill in the art that the number of users in the table may be in the hundreds of thousands or millions, depending on the magnitude of the transaction data available. Table 700 illustrates four transactions of a first user with Profile1 having four records 701, 702, 703, and 704 which enter data for transactions involving two sweatshirts and two T-Shirts. Record 701 indicates user 1 may be in the adult/kid category and purchased a Hanes sweatshirt size M. This transaction by the user was 180 days ago. Record 702 indicates user 1 may be in the adult/kid category and purchased a Tommy Hilfiger T-shirt size L. The transaction was 60 days ago. Record 703 indicates user 1 may be in the adult/kid category and purchased a Banana Republic sweatshirt size XL. The transaction was 15 days ago. Record 704 indicates user 1 may be in the adult/kid category and purchased a Tommy Hilfiger T-shirt size L. The transaction was 180 days ago. The rest of the records indicate information similarly. Obtaining transaction data may be indicated at 620 in FIG. 6. This may result in high confidence signals as indicated at 625 in FIG. 6. However, in some cases, depending on the implementation, the result may be viewed by the implementer as having low confidence, such as having noise in the data. The definition of low confidence may be set by the implementer in accordance with whether the implementer has reason to believe that the data may be accurate enough to use in calculation of relationships among size and brands for a given item. In cases where there may be low confidence of the resulting data, as at 622, it would be intelligent to ask buyers certain targeted questions, in a crowdsourcing sense as at 635, about their sizes so as to get high confidence signals where there may be noise in data. Stated another way, crowdsourcing may give a higher confidence in results than machine learning inasmuch as in crowdsourcing a person may be making a statement and in machine learning, the system may be inferring data.

In FIG. 6, item 600 illustrates the overall work flow described above. Users are asked, as discussed above, to create user profiles 610 of clothing items they purchase, their sizes for those clothing items, the brands, and other data, by asking them to input information relating to the category involved in a format such as:
a. Clothing line (e.g. sweatshirt, T-shirt, Jeans, and the like)
b. Size (e.g. L, XL, XXL based on the clothing line)
c. Brand (e.g. Gap, Banana Republic, Tommy Hilfiger, and other brands)
d. Age Group (e.g. Adults or Kids)
e. Gender (e.g. Male or Female)

The signals (data) from crowdsourcing, via profiles 610 and targeted questions 635 (discussed below), and machine learning, via 620, may be stored in Final User Profile Mapping Data Table 640 which may have data captured from all the above sources at one place. Table 640 may have the following data.
1. PROFILE ID
2. GENDER
3. AGE GROUP
4. Clothing line
5. Brand
6. Size
7. TIMESTAMP
8. SOURCE OF SIGNAL (whether from crowdsourcing or from machine learning (i.e. “transaction data”))

User Profile Mapping Data Table 640 may be seen in more detail in FIG. 8. The table of FIG. 8 illustrates the results of crowdsourced data and also of machine learning data from data mining transaction data available to the ecommerce system. The table of FIG. 8 shows that user 1 has four records 801, 802, 803, and 084. Of these four records, 801(1) and 802(a) indicate that the data of records 801 and 802 are the result of data mining transaction data available to the ecommerce system. 803(a) and 804(a) indicate that the data or records 803 and 804 are crowd sourced data. As was the case for FIG. 7, FIG. 8 indicates only three users. However, since the table of FIG. 8 represents table 640 of FIG. 6 which has the data records from both crowdsourcing and machine learning, it will be appreciated by those of ordinary skill in the art that the number of users in the table may be in the many hundreds of thousands, or even millions, depending on the magnitude of crowdsourcing and machine learning data available to the ecommerce system. The data may continuously change as new transaction data becomes available to the ecommerce system.

At an appropriate time after the user profile mapping data may be stored in 640, relationship mapping as at 650 may be determined algorithmically as discussed below. This may include calculating a signal strength and a confidence score for profile entries. This may be illustrated in FIG. 9 where signal strength may be determined for each profile entry. In this figure there are four records, or entries, for Profile 1, three entries for Profile two, and four entries for Profile 3. A confidence score may be viewed of a function of various factors including, without limitation:

A. The number of entries for a particular clothing line for a profile. In one embodiment this may be done by pair-wise comparison of profile records. For example, if there are two entries for a T shirt, as may be the case for Profile 1 of FIG. 9, that may be viewed as a strong signal.

B. The number of days that have passed since that transaction was made. The longer the number of days, the less confidence in the profile record since a longer number of days may indicate a higher probability that the size in the profile has changed.

C. The variation of the size for the same garment type in a co-occurrence may be too great. For example, there may be an entry of a sweatshirt of XXL size and another entry for a sweatshirt of Medium size for the same user, as in Profile 1 of FIG. 9. This may be viewed as too wide a range to enable confidence in the entries. The threshold for the variation of the sizes being too great may be set by the implementer.

Once the system has the matrix of FIG. 9 completed (as discussed in more detail below) there may be the following possible confidence outcomes:

1. Strong signal but low confidence.

This may be illustrated in FIG. 10 and can happen in cases where a buyer has made two purchases of Banana Republic sweatshirts, but the sizes are considered too far apart to have appreciable confidence. This may happen if the buyer may be not buying for himself but for somebody else.

2. Weak signal and low confidence.

There may be not enough data to enable the system to have any confidence for that profile-garment type combination.

3. Strong signal and high confidence.

The system has enough confidence in the mined data.

There are various ways the confidence of profile entries can be boosted. In one instance, on the search results page when a user has selected a garment type like T-shirts the ecommerce system can ask the user to help update their profile. They may be asked whether Tommy Hilfiger Large size fits them in the particular garment type, or whether Tommy Hilfiger XL fits. This may help the system ask targeted questions to users and help the users quickly answer. When the answer input comes in the system may update its profile entries and boost the confidence score. In a case in which the user does not provide answering data, the system can provide incentives like “unblock new brands that fit you”. This may in the form of a pop-up on a garment type page when the system has low or very little knowledge for that user's profile in that garment type. In one embodiment, the system may ask about two brands and sizes that that the user may be wearing these days and create or update their profile behind the scenes with answering data.

Another way may be to add a pop-up such as “What are you wearing these days?” in a profile pop section. The system may already ask what the user's size is. The system may also ask what brands the user wears. The system may ask additional questions about a particular garment type, for example asking which brand and size combination the user may be wearing these days. Incentives for the buyer may prove to be a better personalized experience.

Yet another way to obtain information from the user may be that a few days after scheduled arrival of the item for a successful transaction the system may enquire of the user if the purchased clothing item fits him or her. That may complete the feedback loop and can boost confidence even further.

### Calculating Relations Between Clothing-Line-Brand-Size: “Relationship Mapping”

The system may calculate the relationship graph 650 of FIG. 6. This may be a relationship of brand and size with a clothing line, gender, and age group. A confidence score may also be calculated for these relations. A confidence score may be based on various factors. These may include, without limitation, the number of co-occurrences in “User profile mapping data” where in a clothing line AND age group AND gender group the data indicates the same occurrences of people wearing Brand “A” in SIZE_BRAND_A also wearing BRAND “B” in SIZE_BRAND_B.

The source of signal in “User profile mapping data” also matters. As discussed above, crowd sourced signals may have higher weightage than machine learned signals.

### Mathematical Process for Size Normalization

In the data, the process for size normalization may begin with finding the co-occurrences for the profiles in the User Profile Mapping Data 640 of FIG. 1, also illustrated by the table of FIG. 8.

### Finding Co-Occurrences

Co-occurrence may be defined as records which have the same Profile/Gender/Age Group/Clothing Line, but different sizes and brands. For the purpose of this patent, we will refer to the term Profile/Gender/Age Group/ClothingLine as a descriptor for ease of reference. A co-occurrence may possibly (based on thresholds discussed below) provide one instance of approximate equality between the sizes of the same clothing line between two brands. For example, In FIG. 13 for Profile 11, there may be one co-occurrence of two records (i.e., two rows, namely, 1310 and 1330), with the same descriptors but different sizes and brands, here Hanes M and Banana Republic XL. The size in each record indicates that sweatshirt size M in Hanes may be approximately the same as a sweatshirt size L in Banana Republic.

As another example, if there were three records in a profile with equal descriptors (but each with a different Brand), then there would be three sets of co-occurrence records. This may be seen in FIG. 13A where the co-occurrences would be records 1340, 1350, records 1340, 1360, and records 1350, 1360.

As a general rule for the data available for the ecommerce system on which this process was run, it was decided that if two records would be a co-occurrence but had a time stamp difference of more than 180 days, these two records should not be selected as a co-occurrence. This may be because the time between occurrences would be considered too long to give an appropriate confidence that the person making the purchases had not changed sizes, larger or smaller, during the time period between time stamps. Other distances between time stamps may be set for non-selection of a record which would otherwise be one record of a co-occurrence, depending on the judgment of the implementers.

Another rule may be set that if there were two records each with equal descriptors and the same brand, for example Brand=Hanes, but one was time stamped earlier than the other. In that case the record which gives minimum timestamp gap between two different brands in one co-occurrence would be chosen. An example of this may be seen in FIG. 13B where, as between records 1370 and 1376, record 1376 may be selected as a co-occurrence record with record 1374 because that gives the minimum timestamp gap between two different records 1374 and 1376.

In general, a co-occurrence in a profile, say profileᵢ, may be defined mathematically as:

CO_{profilei}=Co-occurrence for a Profileᵢ=function(User Profile, Gender, Adult/Kid, Clothing line Brand, TimeStamp)

The records of the co-occurrences of FIG. 13 are illustrated as 1310 and 1320.

### Co-Occurrence Bucketing

Once co-occurrence records are found they may be placed in logical categories or “buckets” in accordance with their time gap by calculating the “Bucket for Time-Gap between the time stamps of two records” for co-occurrences. The “Bucket for Time-Gap between the time stamps of two records” are the buckets for which timegaps are defined, where “timegap” may be the difference between timestamps of two records in days, and may be a positive number.

In general, the time gap between two records in a profile (say, profile i) may be defined as:

BucketTimeGap_{profilei}=“BUCKET FOR TIME-GAP between the timestamps”=function(TimeStamp of record 1, TimeStamp of record 2).

This may be viewed as quantifying the number of days in a time gap into a range, in the series {0.75, 0.80, 0.85, 0.90, 0.95, 1.0}, which may be a series defined for the example of the transaction data available to the ecommerce system. For other systems, with other data available, other series may be chosen. For example, for an ecommerce system that has a shorter period of time that data may be available, or for a clothing line that has been in existence a relatively short time, the numbers in the series may have to be adjusted.

Since, as stated above for the current example, no time gap should be greater than 180 days, the above series {0.75, 0.80, 0.85, 0.90, 0.95, 1.0} quantifies 180 days into six-30 day periods. In general, the lower the time gap, the higher the number in the series assigned to the time gap.

In the example under discussion, the following ranges may be used:

| Time Gap (in days) | Assigned Number |
|---|---|
| 0-30 | 1.0 |
| 31-60 | 0.95 |
| 61-90 | 0.90 |
| 91-120 | 0.85 |
| 121-150 | 0.80 |
| 151-180 | 0.75 |

The numbers in the series are intended to dampen the effect of large time gaps in the calculation of the final confidence score, to be discussed below. In other words, if a time gap may be large, the intent may be to dampen its effect in the confidence score to a greater extent than the effect of a time gap that may be small. This may be because there may be less confidence in sizing that occurred in two transactions or crowdsourced information obtained far apart in time (say 178 days apart) than sizing in transactions that occurred closer together (say 2 days apart). Stated another way, if the time gap between the co-occurrences may be large, the confidence in the sizes of the two records of the co-occurrence may be lower than if the time gap were smaller. Therefore, assigning a number in the above series may be an attempt to dampen the effect of a large time gap.

### Defining Constants for a Multiplication Factor for “Source of Signal”

As discussed above, the Source of Signal may be transaction data or crowdsourced data. Constants may be defined for these two sources. A transaction data constant may be defined as “Tc” and a Crowdsourced constant may be defined as “Cc.” A score for the signal strength for a co-occurence as a function of signal source may be calculated.

First, one may define:
Co-occurrence source of signal for record 1 as SIGNAL_SOURCE_{—}1
Co-occurrence source of signal for record 2 as SIGNAL_SOURCE_{—}2

Then,

Signalcore_{profilei}=function(SIGNAL_SOURCE_{—}1, SIGNAL_SOURCE_{—}2)

If source may be transaction data then the Tc constant may be used. If source may be crowdsourcing then the Cc constant may be used. The calculation may be a simple average of two constants. For example in the example under discussion, seen in FIG. 14 which illustrates that there are two records per co-occurrence:

SignalScore=(Tc+Cc)/2

This may be seen from FIG. 14 which may be an illustration of a co-occurrence in which one source of signal in the co-occurrence may be TRANSACTION DATA and other one may be CROWDSOURCED.

Generally, the intent in the example under discussion may be to dampen the effect of the signals in a co-occurrence that come from transaction data because, in the instance under discussion, transaction data was considered with less confidence than crowdsourced date. This is, of course, dependent on the implementer. The implementer may have high confidence in his or her transaction data so that there may be no, or less, need to dampen the effects of transaction data as a signal source. For the ecommerce system under discussion, the intent may be to dampen the effect of transaction data which may be believed to have a lower confidence factor as compared to crowdsource inasmuch as transaction data may be machine produced whereas crowdsourced data may be from a human stating a size. So transaction data signal source may be set as 0.75 whereas crowdsourced signal strength may set to 1.0 for records in a co-occurrence. Applying this to the example of FIG. 14, in which the source of signal of record 1410 may be transaction data and the source of signal of record 1420 may be crowdsourced data, the transaction data signal source may yield a constant Tc set to 0.75, and crowdsourced signal source may yield a constant Cc set at 1.0. The SignalScore may be then (Tc+Cc)/2=(0.75+1.0)=0.85. If, on the other hand, both signal sources of records 1410 and 1420 were crowdsourced, the SignalScore would be 1.0. Others may set the constants differently depending on circumstances discussed above.

### Defining a Threshold for a Co-Occurrence to Participate in a Confidence Score

In one example, the threshold of co-occurrences needed for participation in a confidence score may be set. The threshold may be 100, and may be called MIN_THRESHOLD. A threshold different than 100 may be set depending on the implementers and the available data. The frequency score for co-occurrence across the profiles may be calculated. As one example, in FIG. 14 there are three co-occurrences, 1410, 1420; 1430, 1440; and 1450, 1460. The co-occurrences may now be aggregated across all profiles in the Final User Profiled Mapping Data 640 of FIG. 6 for the same brand combinations.

The Frequency Score may be computed as:

FREQUENCY SCORE=FreqScore=function(Number of CO_{profile i})

This may return a number in this bucket series {0, 0.75, 0.8, 0.85, 0.90, 1.0).

If “Number of CO_{profile i}” may be less than MIN_THRESHOLD (here 100 co-occurrences) a score of 0 results.
Between MIN_THRESHOLD and 1000 a score of 0.75 results.
Between 1000 and 2000 a score of 0.80 results.
Between 2000 and 3000 a score of 0.85 results.
Between 3000 and 4000 a score of 0.90 results.
Between 4000 and 5000 a score of 0.95 results.
Above 5000 a score of 1.0 results.

Stated another way, the process attempts to give a larger score to a larger number of co-occurrences so that the larger the number of co-occurrences in a particular Gender/Age Group/Clothing Line, the stronger the signal.

The confidence score may then be calculated mathematically:
1. K represents brand A, and L represents brand B.
2. N represents total number of co-occurrences in a particular Gender/Age Group/Clothing Line.
3. “SignalScore_{profile i}” represents signal score for co-occurrence of ith Profile.
4. “BucketTimeGap_{profile i}” represents Bucket time gap for co-occurrence of ith Profile

If FREQUENCY SCORE=0.0 then Confidence Score=0 since the number of co-occurrences would not reach the above threshold of the example.

$$Otherwise , Confidence Score ( Brand K , L ) = \frac{\begin{matrix}( \sum i ⋀ N ( ( ( \begin{matrix}( SignalScore profile i ) + \\ ( BucketTimeGap profile i )\end{matrix} ) ) / 2 ) ) / N ) + \\ ( FREQUENCY SCORE ) )\end{matrix}}{2}$$

where ΣîN means the summation of profileᵢ from 1 to N.

An example relationship graph for “T-shirt and Male and Adults” (“Clothing line” & Gender & Age Group”) may be illustrated in FIG. 11 where the confidence score has been calculated as explained above. The calculation yielded a confidence at 1110 of 0.9 that people who wear a T-shirt in Tommy Hilfiger L size also where a T-shirt in Gap size XL; and a confidence at 1120 of 0.85 that people who wear a T-shirt in Tommy Hilfiger L size also wear a T-shirt in Diesel size L. Similar calculations such as those above, may be made for T-shirts in other pairs of brands. For example, similar calculations may be made for (A) Tommy Hilfiger and Calvin Klein; (B) Tommy Hilfiger and Hanes; (C) Tommy Hilfiger and Hugo Boss; (D) Hugo Boss and Hanes, and (E) Gap and Hanes. The results may be aggregated into a graph such as that of FIG. 12. This will help an ecommerce system making experiences where the site may show items that “fit” a profile rather than items which meet size criteria of such as size “L”.

Operation of the above work flow may be seen in FIG. 15 which is an illustration of an operation of the workflow of FIG. 6 according to an embodiment. At 1510 size and brand information for a descriptor is obtained from machine learning from transaction data available to an ecommerce system. As discussed above, “descriptor” is a term used for ease of reference to mean Profile/Gender/Age Group/ClothingLine. The information collected at 1510 is scanned to find cases for each profile where targeted questions may be asked through crowdsourcing to boost the signal strength because of the cases of low confidence data in machine learnt data. The resulting crowd sourced data at 1530 goes to 1520 as high confidence data. 1520 gets all types of crowd sourced data and 1530 is just once source which feeds to 1520. 1520 also gets data for size and brand information for a descriptor available as crowd sourced data collected in ecommerce system. Only high confidence data from 1510 and all data from 1520 then goes to 1540 where a giant user profile mapping repository is created. From 1540 data is fed to 1550 where co-occurrences are determined. In 1560 signal strength score and a confidence score is calculated for co-occurrences. The signal strength score may be calculated in accordance with whether the data in the co-occurrences was obtained from crowdsourcing or from machine learning. The confidence score may be calculated in accordance with the time gap in the co-occurrences and, in some cases, with whether the data in the co-occurrences was obtained by crowdsourcing or from machine learning. At 1570 the relationship, which may be viewed as size normalization of a given item across brands, may be calculated. A confidence of the size normalization may be calculated in accordance with the signal strength score of the profiles used in the calculation, the bucketing of the profiles use in the calculation, and the calculated frequency score of the profiles used in the calculation.

### Modules, Components, and Logic

Additionally, certain embodiments described herein may be implemented as logic or a number of modules, engines, components, or mechanisms. A module, engine, logic, component, or mechanism (collectively referred to as a “module”) may be a tangible unit capable of performing certain operations and configured or arranged in a certain manner. In certain example embodiments, one or more computer systems (e.g., a standalone, client, or server computer system) or one or more components of a computer system (e.g., a processor or a group of processors) may be configured by software (e.g., an application or application portion) or firmware (note that software and firmware can generally be used interchangeably herein as may be known by a skilled artisan) as a module that operates to perform certain operations described herein.

In various embodiments, a module may be implemented mechanically or electronically. For example, a module may comprise dedicated circuitry or logic that may be permanently configured (e.g., within a special-purpose processor, application specific integrated circuit (ASIC), or array) to perform certain operations. A module may also comprise programmable logic or circuitry (e.g., as encompassed within a general-purpose processor or other programmable processor) that may be temporarily configured by software or firmware to perform certain operations. It will be appreciated that a decision to implement a module mechanically, in dedicated and permanently configured circuitry, or in temporarily configured circuitry (e.g., configured by software) may be driven by, for example, cost, time, energy-usage, and package size considerations.

Accordingly, the term “module” should be understood to encompass a tangible entity, be that an entity that may be physically constructed, permanently configured (e.g., hardwired), or temporarily configured (e.g., programmed) to operate in a certain manner or to perform certain operations described herein. Considering embodiments in which modules or components are temporarily configured (e.g., programmed), each of the modules or components need not be configured or instantiated at any one instance in time. For example, where the modules or components comprise a general-purpose processor configured using software, the general-purpose processor may be configured as respective different modules at different times. Software may accordingly configure the processor to constitute a particular module at one instance of time and to constitute a different module at a different instance of time.

Modules can provide information to, and receive information from, other modules. Accordingly, the described modules may be regarded as being communicatively coupled. Where multiples of such modules exist contemporaneously, communications may be achieved through signal transmission (e.g., over appropriate circuits and buses) that connect the modules. In embodiments in which multiple modules are configured or instantiated at different times, communications between such modules may be achieved, for example, through the storage and retrieval of information in memory structures to which the multiple modules have access. For example, one module may perform an operation and store the output of that operation in a memory device to which it may be communicatively coupled. A further module may then, at a later time, access the memory device to retrieve and process the stored output. Modules may also initiate communications with input or output devices and can operate on a resource (e.g., a collection of information).

### Example Machine Architecture and Machine-Readable Storage Medium

With reference to FIG. 16 an example embodiment extends to a machine in the example form of a computer system 1600 within which instructions for causing the machine to perform any one or more of the methodologies discussed herein may be executed. In alternative example embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, a switch or bridge, or any machine capable of executing instructions (sequential or otherwise) that specify actions to be taken by that machine. Further, while only a single machine may be illustrated, the term “machine” shall also be taken to include any collection of machines that individually or jointly execute a set (or multiple sets) of instructions to perform any one or more of the methodologies discussed herein.

The example computer system 1600 may include a processor 1602 (e.g., a central processing unit (CPU), a graphics processing unit (GPU) or both), a main memory 1604 and a static memory 1606, which communicate with each other via a bus 1607. The computer system 1600 may further include a video display unit 1610 (e.g., a liquid crystal display (LCD) or a cathode ray tube (CRT)). In example embodiments, the computer system 1600 also includes one or more of an alpha-numeric input device 1612 (e.g., a keyboard), a user interface (UI) navigation device or cursor control device 1614 (e.g., a mouse), a disk drive unit 1616, a signal generation device 1618 (e.g., a speaker), and a network interface device 1620.

### Machine-Readable Medium

The disk drive unit 1616 includes a machine-readable storage medium 1622 on which may be stored one or more sets of instructions 1624 and data structures (e.g., software instructions) embodying or used by any one or more of the methodologies or functions described herein. The instructions 1624 may also reside, completely or at least partially, within the main memory 1604 or within the processor 1602 during execution thereof by the computer system 1600, with the main memory 1604 and the processor 1602 also constituting machine-readable media.

While the machine-readable storage medium 1622 may be shown in an example embodiment to be a single medium, the term “machine-readable storage medium” may include a single storage medium or multiple storage media (e.g., a centralized or distributed database, or associated caches and servers) that store the one or more instructions. The term “machine-readable storage medium” shall also be taken to include any tangible medium that may be capable of storing, encoding, or carrying instructions for execution by the machine and that cause the machine to perform any one or more of the methodologies of embodiments of the present application, or that may be capable of storing, encoding, or carrying data structures used by or associated with such instructions. The term “machine-readable storage medium” shall accordingly be taken to include, but not be limited to, solid-state memories and optical and magnetic media. Specific examples of machine-readable storage media include non-volatile memory, including by way of example semiconductor memory devices (e.g., Erasable Programmable Read-Only Memory (EPROM), Electrically Erasable Programmable Read-Only Memory (EEPROM), and flash memory devices); magnetic disks such as internal hard disks and removable disks; magneto-optical disks; and CD-ROM and DVD-ROM disks.

### Transmission Medium

The instructions 1624 may further be transmitted or received over a communications network 1626 using a transmission medium via the network interface device 1620 and utilizing any one of a number of well-known transfer protocols (e.g., Hypertext Transfer Protocol (HTTP)). Examples of communication networks include a local area network (LAN), a wide area network (WAN), the Internet, mobile telephone networks, Plain Old Telephone Service (POTS) networks, and wireless data networks (e.g., WiFi and WiMax networks). The term “transmission medium” shall be taken to include any intangible medium that may be capable of storing, encoding, or carrying instructions for execution by the machine, and includes digital or analog communications signals or other intangible medium to facilitate communication of such software.

Although an overview of the inventive subject matter has been described with reference to specific example embodiments, various modifications and changes may be made to these embodiments without departing from the broader spirit and scope of embodiments of the present application. Such embodiments of the inventive subject matter may be referred to herein, individually or collectively, by the term “invention” merely for convenience and without intending to voluntarily limit the scope of this application to any single invention or inventive concept if more than one is, in fact, disclosed.

The embodiments illustrated herein are described in sufficient detail to enable those skilled in the art to practice the teachings disclosed. Other embodiments may be used and derived there from, such that structural and logical substitutions and changes may be made without departing from the scope of this disclosure. The Detailed Description, therefore, may be not to be taken in a limiting sense, and the scope of various embodiments may be defined only by the appended claims, along with the full range of equivalents to which such claims are entitled.

Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present application. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present application as represented by the appended claims. The specification and drawings are, accordingly, to be regarded in an illustrative rather than a restrictive sense.

1. A method comprising:
obtaining from crowdsourcing and data mining, by at least one computer processor, size and brand information for a plurality of descriptors, the descriptors including item types and associated with user profiles;
determining and categorizing co-occurrences among descriptors;
calculating signal strength and confidence scores for the co-occurrences; and
calculating relationships between sizes and brands for the item types.

2. The method of claim 1 further comprising boosting confidence for machine learned data with low confidence.

3. The method of claim 2 wherein boosting confidence for machine learned data with low confidence comprises asking targeted questions to users.

4. The method of claim 2 wherein low confidence data from machine learning is picked based on at least one of the quantities consisting of a frequency score for a particular item type for a profile, the number of days that have passed since the capture of a transaction in a profile record, and the variation in size for the same item type in a profile.

5. The method of claim 1 wherein calculating signal strength uses a constant number for dampening the effect of signals in a co-occurrence that come from machine learning data.

6. The method of claim 1 wherein the records of a co-occurrence include time stamps and categorizing descriptors comprises placing co-occurrences into logical categories based on the time-gap between time stamps of two records of the co-occurrence.

7. The method of claim 1 wherein the confidence of the relationships may be calculated based on the signal score of profile of co-occurrences, the time-gap between records of co-occurrences, and frequency scores of profiles used in calculating the relationships.

8. A machine-readable storage device having embedded therein a set of instructions which, when executed by a machine, causes execution of the following operations:
obtaining from crowdsourcing and data mining, by at least one computer processor, size and brand information for a plurality of descriptors, the descriptors including item types and associated with user profiles;
determining and categorizing co-occurrences among descriptors;
calculating signal strength and confidence scores for the co-occurrences; and
calculating relationships between sizes and brands for the item types.

9. The machine-readable storage device of claim 8 further comprising boosting confidence for co-occurrences with low confidence.

10. The machine-readable storage device of claim 9 wherein boosting confidence for co-occurrences with low confidence comprises asking targeted questions to users.

11. The machine-readable storage device of claim 9 wherein low confidence data from machine learning is picked based on at least one of the quantities consisting of a frequency score for a particular item type for a profile, the number of days that have passed since the capture of a transaction in a profile record, and the variation in size for the same item type in a profile.

12. The machine-readable storage device of claim 8 wherein calculating signal strength uses a constant number for dampening the effect of signals in a co-occurrence that come from machine learning data.

13. The machine-readable storage device of claim 8 wherein the records of a co-occurrence include time stamps and categorizing descriptors comprises placing co-occurrences into logical categories based on the time-gap between time stamps of two records of the co-occurrence.

14. The machine-readable storage device of claim 8 wherein the confidence of the relationships may be calculated based on the signal score of profiles in co-occurrences, the time-gap between records of co-occurrences, and frequency scores of profiles used in calculating the relationships.

15. A system comprising:
one or more computer processors configured to
obtain, from crowdsourcing and data mining, size and brand information for a plurality of descriptors, the descriptors including item types and associated with user profiles;
determine and categorizing co-occurrences among descriptors;
calculate signal strength and confidence scores for the co-occurrences; and
calculate relationships between sizes and brands for the item types.

16. The system of claim 15 the one or more computer processors further configured to boost confidence for co-occurrences with low confidence.

17. The system of claim 15 wherein low confidence data from machine learning is picked based on at least one of the quantities consisting of a frequency score for a particular item type for a profile, the number of days that have passed since the capture of a transaction in a profile record, and the variation in size for the same item type in a profile.

18. The system of claim 15 wherein calculating signal strength uses a constant number for dampening the effect of signals in a co-occurrence that come from machine learning data.

19. The system of claim 15 wherein the records of a co-occurrence include time stamps and categorizing descriptors comprises placing co-occurrences into logical categories based on the time-gap between time stamps of two records of the co-occurrence.

20. The system of claim 15 wherein the confidence of the relationships may be calculated based on the signal score of profiles in co-occurrences, the time-gap between records of co-occurrences, and frequency scores of profiles used in calculating the relationships.
